(19) United States
(12) Patent Application Publication
(10) Pub. No.: US 2008/0313017 A1
(43) Pub. Date: Dec. 18, 2008

(54) METHODS AND APPARATUS TO WEIGHT INCOMPLETE RESPONDENT DATA

(76) Inventor: John C. Totten, Lisle, IL (US)

Correspondence Address: HANLEY, FLIGHT & ZIMMERMAN, LLC, 150 S. WACKER DRIVE, SUITE 2100, CHICAGO, IL, 60606, US

(21) Appl. No.: 12/138,604

(22) Filed: Jun. 13, 2008

Related U.S. Application Data
(60) Provisional application No. 60/944,005, filed on Jun. 14, 2007.

(51) Int. Cl. G06Q 10/00; G06Q 30/00

(52) U.S. Cl. 705/10

(57) ABSTRACT

Methods and apparatus to weight incomplete respondent data are disclosed. An example method includes assembling a set of complete data, assembling a set of incomplete data, and selecting a channel of interest. The example method also includes estimating activity within the selected channel, and calculating synthetic time indicies for the set of incomplete data.

### RELATED APPLICATION

This patent claims priority from U.S. Provisional Application Ser. No. 60/944,005, entitled “Methods and Apparatus to Weight Incomplete Respondent Data” filed on Jun. 14, 2007, and is hereby incorporated by reference in its entirety.

### FIELD OF THE DISCLOSURE

This disclosure relates generally to market research, and, more particularly, to methods and apparatus to weight incomplete respondent data.

### BACKGROUND

Producers of goods and/or services find value in determining behaviors of consumers so that marketing, design, and/or distribution efforts of such goods and/or services may be tailored to achieve significant market penetration. Such goods and/or services may be sold, marketed, and/or distributed through one or more channels such as channels related to, but not limited to, food, groceries, mass retailers, Internet purchasers, and/or viewership (e.g., broadcast television, cable television, satellite television, etc.). Generally speaking, if a producer, designer, and/or manufacturer understands, for example, purchasing behavior, then factors related to the success and/or failure of the purchase behavior may be identified and possibly improved upon.

As described herein, a respondent includes a consumer, such as an individual, a household, and/or a business that purchases goods and/or consumes services. Respondents, such as a group of consumers (e.g., a panel) that provides information at a point in time and/or over a period of time, typically provide information related to behavior of interest to one or more researchers. Additionally, the producers, marketers, and/or sellers of goods and/or services that seek to observe respondent behaviors may be interested in studying one or more behaviors that include any activity, such as, for example, product purchases, usage of Internet services, and/or the viewing of media (e.g., broadcast television).

Determining respondent behaviors may include employing one or more statistical analyses of data collected from panelists that are selected to represent one or more particular geographic and/or demographic aspects of a universe. For example, respondent behaviors related to consumer volume activity may include components of volume sales, which include population, penetration, transactions per buyer, and/or volume per transaction. The population may represent a size of the total pool from which purchasers are drawn. The penetration may represent a fraction of the total population that purchases a product within a time period. The transactions per buyer may represent an average number of distinct purchase occasions in a period. The volume per transaction may represent an average purchase size in the time period.

In view of the panelist data collected, projections may be made to determine values (e.g., components of volume sales) for the larger universe of respondents. A relatively high degree of confidence may result in the projections made from panelist data because the collected data is complete. In other words, entities chartered with the responsibility of selecting panelist households typically monitor the household members' behaviors in relatively great detail. Entities chartered with the responsibility of designing, managing, and/or implementing panelist studies may employ procedures in which panel members document behaviors (e.g., shopping purchases, television viewing, etc.) in a diary, and/or may employ procedures to non-invasively monitor the panel members' behavior with one or more monitoring devices. For example, Nielsen Media Research® employs Active/Passive (A/P) meters to determine the identify of a panel member and any particular media that the panel member is watching. Similarly, Spectra Marketing employs a Homescan® Product Library (HPL) that, in part, incorporates purchase data from over 60,000 panel households. Information collected from such households includes consumer purchase activity and/or one or more demographic subgroups of interest to allow producers of goods and/or services to determine respondent behaviors in a market of interest.

Irrespective of the type of behavior being monitored, a relatively high degree of confidence in behavior projections from one or more samples to a larger universe is realized if the panel data analysis is based upon a substantial fraction of all behavior in the category and/or channel being analyzed. As such, maintaining and facilitating robust panelists to generate complete behavior data typically requires a corresponding high degree of expense. For example, households selected by Nielsen Media Research® are selected based on statistical methods to verify that each relevant demographic subgroup is properly represented. Maintaining a panel involves other expenses. For example, selected households typically require monitoring equipment, the monitoring equipment must be installed, household members must be trained to use the monitoring equipment, and/or efforts must be made to ensure the household members comply with monitoring procedures. Households that fail or may fail to comply with the strict participation procedures are typically removed from consideration, and alternate households must be located, provided with equipment, installed, trained to use the monitoring equipment, and monitored for compliance, thereby consuming a significant amount of cost and effort to the research entity (e.g., Nielsen Media Research®).

### BRIEF DESCRIPTION OF THE DRAWINGS

FIG. 1 is a graph representing example volume projections of complete and incomplete data.

FIG. 2 is a block diagram of an example system to weight incomplete respondent data.

FIG. 3 is a flowchart representing example machine readable instructions that may be executed to implement the example system to weight incomplete respondent data of FIG. 2.

FIG. 4 is a flowchart representing example machine readable instructions that may be executed to implement database assembly by the system of FIG. 2.

FIG. 5 is a flowchart representing example machine readable instructions that may be executed to implement channel spending estimations by the system of FIG. 2.

FIG. 6 is an example table to illustrate channel spending estimation.

FIGS. 7A and 7B are flowcharts representing example machine readable instructions that may be executed to implement seasonal factor adjustments by the system of FIG. 2.

FIG. 8 is an example table to illustrate seasonal index calculations.

FIG. 9 is a flowchart representing example machine readable instructions that may be executed to implement calculation of synthetic time by the system of FIG. 2.

FIG. 10 is an example table to illustrate example synthetic time calculation.

FIG. 11 is a block diagram of an example processor system that may be used to execute the example machine readable instructions of FIGS. 3-5, 7A, 7B and/or 9 to implement the example systems, apparatus, and/or methods described herein.

### DETAILED DESCRIPTION

Consumer behavior in a broad range of frequently performed behavioral classifications (such as product purchasing, television viewing, purchases of consumer services, etc.) is typically studied by collecting complete information on a limited number of panelists. Such panelists are typically associated with demographic information that may be used to project panel activity to larger groups of consumers. In other words, a panelist may be a respondent that is recruited and managed in a manner designed to encourage complete reporting of information. However, problems may arise when many participants in a data collection project fail to meet one or more criteria for completeness of behavioral information. Such participants are typically dropped from the analysis because their information is incomplete. Criteria for collected data to be deemed complete include, but are not limited to, accountability for all time of panelist behavior, and accountability for all retailers, merchants, and/or services used by the panelist member(s). Additionally, automated data collection from sources such as retailer point of sale (POS) scanning, monitoring of Internet activity, non-panelist group(s), retailer-specific (e.g., loyalty card) programs, and/or television (e.g., cable, satellite, broadcast, etc.) monitoring have produced large amounts of data known to be partially complete (sometimes referred to as incomplete data).

Attempting to apply typical panel completeness test(s) to incomplete data may identify a subset of households that exhibit severe selection biases that are not deemed representative of the larger population. Academic and commercial methods are employed to estimate the degree of completeness for each consumer unit for which partial data is available, and may estimate potential increase(s) in activity that might be realized from programs (e.g., promotions) designed to increase the fraction of total activity devoted to the collector (e.g., retail store). However, such academic and commercial methods do not project results based on incomplete data to a larger universe or population of consumers. As used herein, a universe may identify a group of consumers for which total group estimation information is desired. Such estimations are typically calculated based on one or more observations of behavior for a smaller subset of members of the universe.

Accordingly, the example methods and apparatus described herein combine complete and incomplete data in a manner that generates fractional projection weights assigned to each provider of incomplete information, and allows projection of such incomplete data onto a statistical expectation of results that are typically expected from complete data. Such projection(s) permit calculation of measures including, but not limited to, market share, brand penetration, and/or volumes per purchaser. Additionally, the projection(s) consider a period of time (e.g., a week, a month, etc.) to which the calculations pertain, such as, for example, a penetration related to a fraction of buyers engaged in one or more activities for the selected period. In part, the methods and apparatus described herein allow the utilization of data from panelists that fail to meet typical criteria for inclusion of a statistical projection. Despite the failure to meet such criteria of completeness, the methods and apparatus described herein utilize the incomplete data from alternative data sources, such as data from respondent(s) whose data is not managed, and/or managed without a typical indicia of statistical completeness.

Sources of incomplete data (e.g., non-panelist data, retail preferred shopper card data, etc.) are available in increasing numbers and cost very little when compared to sources of complete data (e.g., panelist data). For example, incomplete data, such as data from loyalty card programs from a grocery store/chain are widely available. Grocery stores grant a respondent a loyalty card, for example, that may be presented during check-out and entitle the respondent to one or more discounts. Each purchase made by the respondent may be captured (e.g., bar codes, SKUs, etc.) to learn which items were purchased, purchase quantities, and a date of purchase to be associated with the respondent's name, address, and/or other personal information. However, respondent behavior analysis techniques that project to a larger universe of consumers do not consider such incomplete data sources because they fail to represent a complete timeline of the respondent activity. That is, while the details of the respondent purchase activity for one particular retailer/chain is complete with respect to that retailer, such details do not represent behaviors external to that retailer. Although the above example relates to grocery store/chain loyalty card data, television viewing data from a household receiver, such as a single receiver in a multi-receiver household, is also widely available. Accordingly, entities chartered with the responsibility of projecting behaviors to a larger universe based on panelist data exclude such incomplete data.

Additionally, computers and storage systems (e.g., databases, hard-drives, data repositories, scanning systems, etc.) have become more powerful and cost effective, incomplete data sources have become more available. While the incomplete data sources have previously been constrained to a limited purpose for the immediate retailer and/or chain of retailers, the methods and apparatus described herein permit such incomplete data to be applied in a manner that facilitates one or more projections to a larger universe of consumers. For example, a retailer and/or chain of retailers typically implement systems to track behavior within one or more stores associated only with that retailer. As described above, an example of such a system is an incentive program for customers (respondents). Incentive programs may include, but are not limited to, loyalty card programs in which the respondents receive an identification card in exchange for demographic and/or geographic information (e.g., age, sex, address, family size, number of children, etc.). The loyalty card entitles the respondent to discounts during checkout. The retailer may employ the purchase behavior data obtained via the loyalty card program tracking to, for example, specifically tailor marketing efforts to the respondent (e.g., coupons for desired products, discounts, specials, etc.). The methods and apparatus described herein facilitate, in part, the ability to expand the usefulness of the incomplete data beyond the immediate retailer and/or chain of retailers.

While the examples above describe incomplete data for a channel of distribution related to a retail store, such as, for example, a grocery store, the methods and apparatus described herein are not limited thereto. Channels of distribution to which the methods and apparatus described herein may apply include, but are not limited to, food, grocery, traditional (e.g., brick and mortar-type) retailers, Internet retailers, and/or mass-media channels (e.g., broadcast television and/or radio, satellite media, cable media, etc.). To the extent that retailers and associated loyalty card incomplete data sources are described, such examples are provided for illustrative purposes and are not intended to limit the scope of the subject matter described herein.

While the incomplete data source contains abundant information related to, in this example, consumer behavior relating to a particular retailer, traditional panel methods of analysis do not utilize this data because the purchase history for an individual respondent reflects only a fraction of the respondent's total purchasing (a fractional purchase history). For example, while the incomplete data may reflect that the respondent spent $150 each month with the retailer for groceries, this value may only represent 40% of what that respondent spends in total for the grocery channel each month, with 60% being spent at any number of other unknown grocery channel sources. To the extent that attempts to analyze this incomplete data with traditional panel methods and establish a static sample criteria to qualify households believed to spend a large fraction of grocery channel purchases with that retailer have been made, these attempts have a limited degree of confidence because a major proportion of shoppers and volume are excluded. Moreover, such static criteria that assume one or more respondents shop primarily with one retailer/chain involve bias and skew in view of a potential disparity between infrequent (light) shoppers versus frequent (heavy) shoppers.

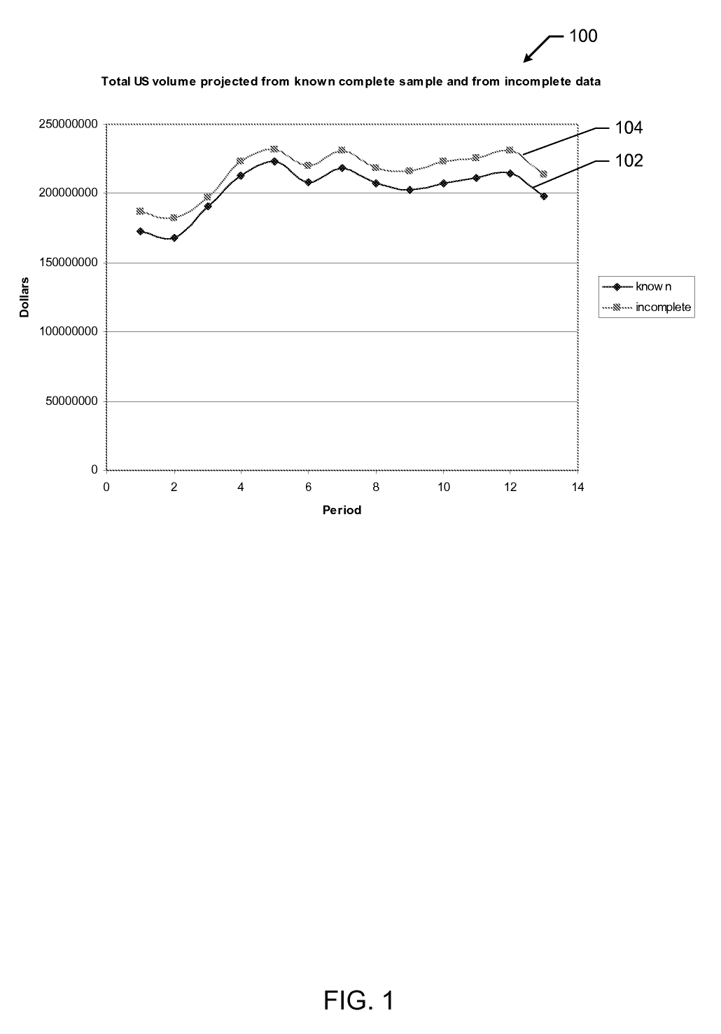

At least some examples of the present disclosure overcome these problems and realize the inherent value of the incomplete data without attempting to force it into the traditional panel analysis methods. In particular, in such examples, behavior represented by the incomplete data (e.g., loyalty card data, fractional purchase history, television viewing data, etc.) is normalized and projection weights are assigned to enable extraction of behavior estimates to a larger universe of consumers (e.g., a regional subgroup and/or a national subgroup) with surprisingly higher confidence. In particular, FIG. 1 illustrates a chart 100 of trial results using the incomplete data with the methods and apparatus described herein. The example chart 100 includes a volume projection trend for known (complete) data 102, and a volume projection trend for incomplete data 104. The complete trend 102 and incomplete trend 104 further illustrate that the projected level for the selected product observed is close (e.g., each of the complete trend 102 and the incomplete trend 104 are not separated by a large y-axis value), and strongly matched (e.g., each of the complete trend 102 and the incomplete trend 104 track a similar profile)

Generally speaking, and as described in further detail below, the methods and apparatus described herein employ an incomplete behavior database, a complete behavior database, and a geodemographic database to weight incomplete respondent data. Such data from the databases is assembled together in view of available geodemographic information to, in part, identify regions where seasonal influences may play a part in consumer behavior. A channel is selected by a user of the methods and apparatus described herein that may include, but is not limited to, channels related to grocery supermarkets, pharmacies, mass-merchandisers, club stores, convenience stores, and/or television viewing behavior studies. For example, in the event that a selected channel is related to grocery shopping, data from supermarkets, drug stores, mass-merchandisers, club stores, and/or convenience stores may be employed. Additionally or alternatively, in the event that a selected channel is related to prescription drug purchasing, data from pharmacies, mail order pharmacies, doctor prescription summaries, and/or health insurance records may be employed. Without limitation, in the event that a selected channel is related to television viewing, then data from one or more viewing records may be employed such as, for example, over the air broadcast tuning, cable tuning, satellite tuning, digital video recorder data, and/or internet downloading information.

Based on the selected channel, the methods and apparatus described herein determine seasonal factors that may be relevant, such as typical trends expected for barbecue sauce during the winter months, golf equipment sales during the winter months in Northern regions (versus Southern regions), etc. However, seasonal factors are not limited to geographic parameters, but may include one or more demographic parameters, such as income and/or family size, which may influence the types and frequency of observed behaviors of interest. Channel estimations are performed with one or more statistical and/or scoring functions to allow for the calculation of synthetic time, which is used to calculate weighting values for the incomplete respondent data.

### Database Assembly Engine

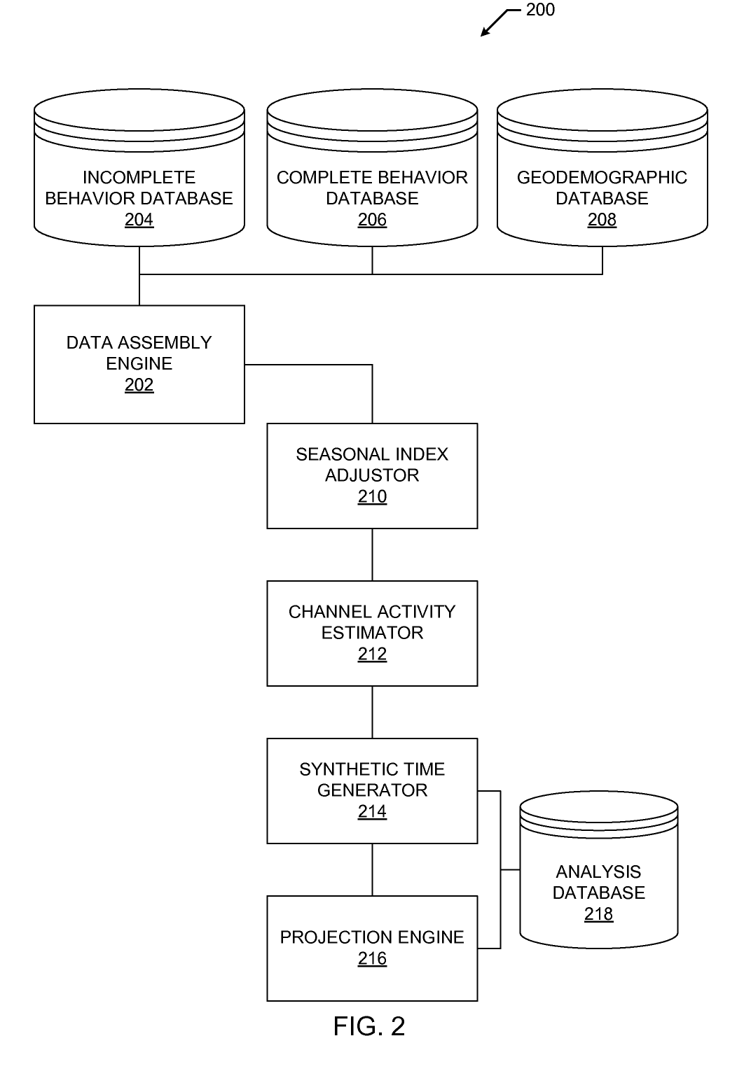

Referring to FIG. 2, an example system 200 to weight incomplete respondent data is shown. In the illustrated example of FIG. 2, the system 200 includes a data assembly engine 202 to assemble data from an incomplete behavior database 204, a complete behavior database 206, and a geodemographic database 208. As described in further detail below, the example incomplete behavior database 204 of FIG. 2 may include data from a set of respondents, such as retail shoppers, that participate in a loyalty card and/or preferred shopper program. The example complete behavior database 206 of FIG. 2 may include data from a set of respondents that represents behavior data collected under generally accepted standards for complete data coverage for the type of behavior to be analyzed. In particular, the complete behavior database 206 may be a panel database such as the Homescan® Product Library (HPL), which includes a panel of over 60,000 national households and profiles of approximately 16,000 product categories for food, drug, mass-merchandiser, and/or convenience channels.

Additionally, the geodemographic database 208 may be one or more information sources constructed from historical analyses of consumer behavior (e.g., spending) generated by, for example, the U.S. Department of Commerce and/or the U.S. Bureau of Labor Statistics. Generally speaking, the example geodemographic database 208 of FIG. 2 may include any characteristics of purchasers (the term “purchaser” is used herein as any unit of behavioral analysis, such as an individual person (e.g., shopper(s), viewer(s)), businesses, and/or one or more family unit(s)), such as the zip codes and ages of the purchasers, the gender of the purchasers, the income of the purchasers, and/or descriptions of the statistical distribution of total spending in a particular channel over a time period. For example, such a description may identify that the average U.S. household annual spending in the grocery channel may be approximated by a positive fraction of normal distribution having a mean of $5000 and a standard deviation of $3000.

The example system 200 to weight incomplete respondent data shown in FIG. 2 also includes a seasonal index adjustor 210, a universe activity estimator 212, a synthetic time generator 214, a projection engine 216, and an analysis database 218.

### Seasonal Index Adjustor

Some activities that are studied by market researchers are subject to seasonal fluctuations of activity. For example, mass merchandisers typically have a strong selling season in the United States between the Thanksgiving and New Years holidays, in which overall sales may average 30% to 50% higher per period (e.g., per day, per week, per month, etc.) than would otherwise occur during alternate period(s). Similarly, television viewing typically enjoys more viewers during winter months versus the summer months, and sales of sporting equipment also tend to exhibit seasonal fluctuation(s). Such variations are not limited to one or more periods, but may be influenced by climate related variations. For example, sales of golfing equipment typically exhibit much greater seasonal variation in northern states (e.g., Minnesota) than do states having a more temperate and/or homogonous climate (e.g., Florida). To account for such effects, the seasonal index adjustor 210 uses the complete data source(s) to calculate an index of per-period activity levels per respondent relative to the total set of periods being studied. As described in further detail below, the seasonal index adjustor 210 generates a seasonality factor/index, which represents the average annualized rate of the activity per respondent in the period indexed to the average annualized rate of the activity per respondent across the whole set of periods used in the analysis of the relation between complete and incomplete data sources.

### Channel Activity Estimator

As described in further detail below, the channel activity estimator 212 employs the complete data as a guide to estimate total activity for an observed respondent from the incomplete data. Without limitation, channel activity may include spending behavior, on-line activity, media viewing behavior, etc. While at least one approach to estimating channel activity may include a direct estimation based on, for example, directly asking each respondent to describe their behavior (e.g., survey techniques), channel activity estimations are more typically performed via a statistical estimation. For example, for each respondent (e.g., a purchaser, a person and/or other entity such as a business), actual activity (e.g., spending) recorded in the complete 206 and incomplete 204 database is summarized and combined by the channel activity estimator 212 with information in the geodemographic database 208 to obtain an estimate of total channel activity per unit of time.

An example estimation of total channel activity includes an estimation of excess life. In particular, if R is a random or pseudo-random variable described by a probability density function f(x) that is defined for any real number x, and one particular occurrence of R is known to have a value X, then the expected value of that occurrence R can be determined for varying values of X. Equation 1 illustrates that R satisfies a probability density function f(x).

$${\int }_{- ∞}^{∞} f ( x ) d x = 1. \qquad Equation 1$$

As a result, the probability that R is less than or equal to X is shown by Equation 2.

$${\int }_{- ∞}^{X} f ( x ) d x = F ( X ) . \qquad Equation 2$$

On the other hand, the probability density function, given that R is greater than or equal to X, is f(x)/(1-F(X)). Thus, the expected value of R, given that R is greater than or equal to X, is shown in Equation 3.

$${\int }_{X}^{∞} \frac{f ( x ) d x}{( 1 - F ( X ) )} = \begin{matrix}Expected Value \\ of R when R \geq X .\end{matrix} \qquad Equation 3$$

Equation 3 is made available as a function call in many existing computer statistical packages. Estimations of channel activity may be added to a geodemographic file as one or more facts. Additionally, other facts may be generated from such estimates in view of particular activity periods of interest. For example, the estimated channel activity may be divided by the number of periods used in the calculation to obtain an average channel activity per period. For instance, if an annual basis estimation includes one-week periods, then an average channel spending estimate may be divided by 52 to determine average spending per week.

Prior art data analysis techniques assigned a respondent a weight of one or zero for a study based on whether the respondent participated for the whole analysis period, or whether the respondent had periods of inactivity, respectively. If certain thresholds of inactivity are exceeded, then the respondent (and associated data associated therewith) is thrown out of the prior art study that employs such traditional analysis techniques. Therefore, despite a vast wealth of information contained within sets of incomplete data (e.g., loyalty card grocery programs), such incomplete data is discarded by prior art techniques and more expensive forms of complete data must be employed.

### Synthetic Time Generator

A problem encountered when attempting to employ incomplete data to analyze behavior in real time is that the probability of any particular behavior is related to the amount of such activity occurring over a larger interval of time. However, a measure of the activity over the larger time interval is typically absent with respect to incomplete data. The synthetic time generator 214 of the illustrated example overcomes this problem by, in part, assigning a non-negative (but possibly zero) weight to each respondent. This weight may vary from time-period to time-period based on observed levels of activity, versus activity levels expected from a respondent with similar geodemographic characteristics.

In other words, in the example of FIG. 2, analysis time is not measured with conventional time units, but is instead measured in synthetic time units in which the behavior at a particular moment is divided by the estimated repetition of that annual behavior per week. In terms of a purchasing-type behavior, the synthetic time approach described herein may be referred to as a share of all commodity volume requirements (SOAR) per week (i.e., a SOAR week). The SOAR week may be represented as the product of 52 weeks times the dollars spent in a household for a product (or chain) for a given week, divided by the total all commodity volume (ACV) spending by that household in one year.

For example, if a partitioned time period employed by the example channel activity estimator 212 was four-week periods during a total time period of one year, and the seasonal index adjustor 210 calculated a seasonal index value of 0.76, then a fractional weight may be calculated from the incomplete data, as shown in Equation 4.

$$Fractional Weight = \frac{( PR ) ( X ) ( S )}{Y} . \qquad Equation 4$$

In example Equation 4, PR is the partition ratio, which in this example would be 13 (i.e., 52 weeks divided by 4-week periods), X is the incomplete activity of a period, S is the seasonal adjustment factor, and Y is the complete activity estimate generated by the example channel activity estimator 212. In effect, the calculation of fractional weight in this manner operates as a surrogate for time. The total estimated activity (e.g., spending or any other behavior) is known for a particular consumer. Thus, the observed activity by that consumer as a fraction of the estimated total activity (e.g., over 1-year) is treated as the surrogate for time in view of the incomplete data.

Results from the example synthetic time generator 214 of FIG. 2 are summarized in the analysis database 218. The example analysis database 218 of FIG. 2 may be arranged as any number of projection cells that correspond to geographic and/or demographic sub-groups. As described above, the HPL by Spectra® Marketing and ACNielsen® operates and maintains a panel of households in which grids identify particular subgroups of interest. For example, one subgroup (grid) may identify measures related to an age category of 60-65, in which the age category may further break-down into subcategories related to particular regions of the U.S. Similarly, the example analysis database 218 of FIG. 2 summarizes and stores results from the synthetic time generator 214 for later use during an analysis of complete and/or incomplete data.

The example summary stored in the example analysis database 218 of FIG. 2 includes, for each geodemographic cell within a period, a count of incomplete respondents with non-zero activity in the period/demographic cell, a sum of the fractional projection weights, an indication of observed total activity, a sum of channel activity for respondents with non-zero projection weights, and/or a sum of other behaviors of interest (e.g., purchase of specific products, viewing of specific television channels/shows, etc.). Such summary information may facilitate an estimate of both full coverage buyers and non-buyers within a particular cell/period. In particular, weights associated with a sum of the fractional projection weights may be employed to serve as an estimate of equivalent full coverage buyers, while the channel activity estimator 212 may employ complete data to determine a fraction of respondents that do not participate in the particular behavior.

### Projection Engine

As described in further detail below, the summarized data in the example analysis database 218 of FIG. 2 is tabulated (calculated) by the example projection engine 216 of FIG. 2 to, in part, project to a desired universe. The summarized data and projection factors/indicies may be projected to the desired universe using any desired projection method(s) based on one or more demographic compositions. However, in the illustrated example, data to be tabulated is first extracted based on meeting qualification parameters, such as desired time intervals, purchaser demographics, purchaser shopping activity, and/or shopper purchasing behavior. For example, a desired time interval may be expressed as “Behavior during the calendar year 2007 only,” or “Behavior during the 3^{rd} quarter of 2006.” Additionally, an example qualification for purchaser demographics may be expressed as “Restrict analysis to households residing in the state of Wisconsin,” or “Restrict the analysis to households with children.” Qualifications based on purchaser shopping activity may be represented, for example, by tabulating only such behavior based on a threshold number of shopping occasions and/or monetary expenditures.

Some analysis and/or tabulation of incomplete data may be more susceptible to varying degrees of captured behavior (e.g., purchasing activity). As such, in some examples, qualification of data stored in the example analysis database 218 also includes selecting only such data that meets a threshold ratio of synthetic time to real time. To this end, a real time interval start and end period is defined, and an example qualification statement may be represented as, for instance, “Include all successive transactions after Aug. 17, 2006 as long as the total purchaser cumulative channel expenditures in the time interval from Aug. 17, 2006 until the transaction is at least 80% of the expected expenditures for that period.”

The qualification statement(s) may be facilitated in any desired manner including, but not limited to, database engine query instructions. For example, the analysis database 218 of FIG. 2 may receive one or more qualification statements and/or instructions from the example synthetic time generator 214 and/or the example projection engine 216 as one or more structure query language (SQL) statements.

Example measures that result from tabulating qualified data include, but are not limited to, population measure(s), purchaser measure(s), duration measure(s), transaction measure(s), compound measure(s), and/or projection factor(s). Generally speaking, population measure(s) may represent a summary of data across all qualified purchasers, such as a count of how many purchasers were included in an analysis. For complete data, population measure(s) may be employed as a weighting factor during the analysis. However, for population measure(s) determined from incomplete data, a ratio of total synthetic time for the purchaser (e.g., the respondent) may be employed. As such, each purchaser is treated as a fractional unit that is defined by the ratio of total synthetic time periods observed for the purchaser to the total time periods in the entire analysis period, which yields an equivalized population.

To illustrate, if 1000 purchasers (e.g., people) are observed for one year, and their total synthetic time is determined (e.g., by the example synthetic time generator 214) to be 3120 weeks, then the equivalized population is represented by Equation 5.

$$Equivalized Population = \frac{( ST )}{( TAP )} . \qquad Equation 5$$

In example Equation 5, ST is the synthetic time of 3120 and TAP is the total analysis period. In the example above, the TAP is 52 weeks, thereby resulting in an equivalized population of 60 rather than 1000. Accordingly, this synthetic time forms the basis for a projection factor to allow projection of individual respondents to equivalized respondents. Furthermore, Equation 5 facilitates application of a projection weight to project the equivalized units to a desired total population.

As described above, data tabulation may also reveal one or more respondent measure(s), which summarize counts and/or data for selected respondents based on purchase behavior. A count respondent measure represents how many purchasers were included based on selection criteria, which includes, for example, category buyer criteria (i.e., those buyers that purchased within a category at least one time), brand buyer criteria (i.e., those buyers that purchased a particular brand at least one time), and/or deal buyer criteria (i.e., those buyers that took advantage of a promotional activity for one or more purchases).

Data tabulation may also create one or more duration measures, which summarize activity behavior (e.g., purchasing, viewing, etc.) over selected real time durations. Duration measures are typically expressed in time units and contain information related to the one or more events that trigger a start and end of the measurement. For example, a pair purchase cycle represents an average number of days between consecutive transaction occasions among purchasers with two or more transactions. Additionally, a trial incidence cycle represents an average number of days from the introduction of a new product to its first purchase.

Other measures that may be realized by tabulating the data include transaction measures, which summarize information about purchase behavior on shopping occasions. Examples of transaction measures include a total number of transactions, a total transaction dollar spending, and/or a total transaction purchase volume. The transaction measures may also include transaction counts, transaction volume, or transaction dollars associated with one or more types of promotional activities (e.g., coupons, advertising, in-store displays, etc.). Measures derived from tabulating the data may also be combined to generate compound measures. For example, application of arithmetic operation(s) to measures already determined may allow calculation of a volume per buyer compound measure, (e.g., by dividing volume by a number of buyers).

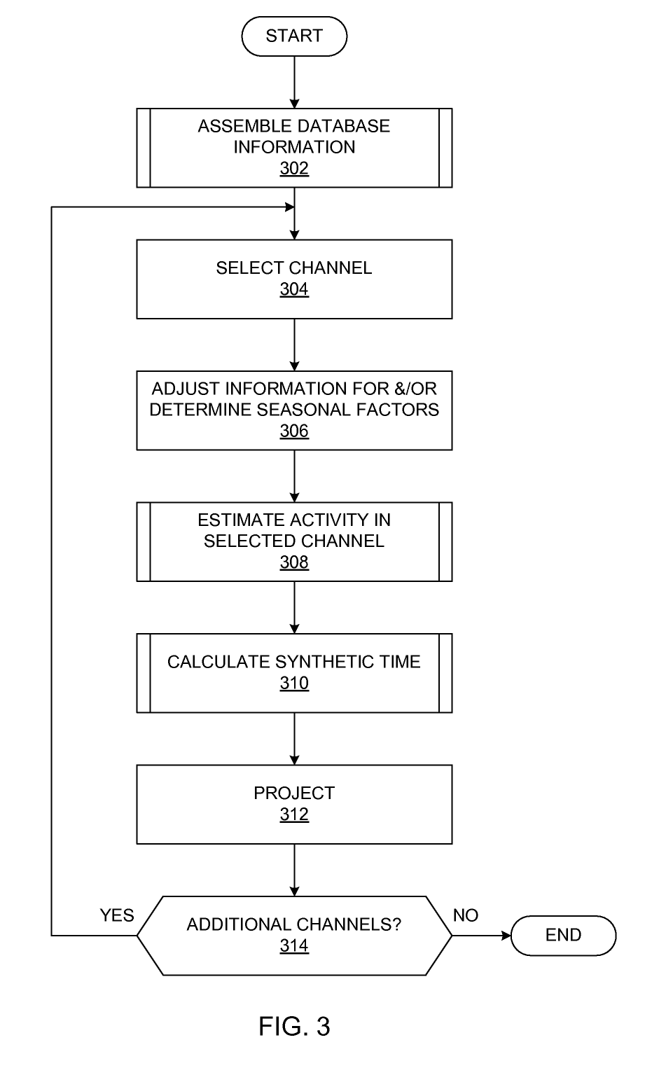

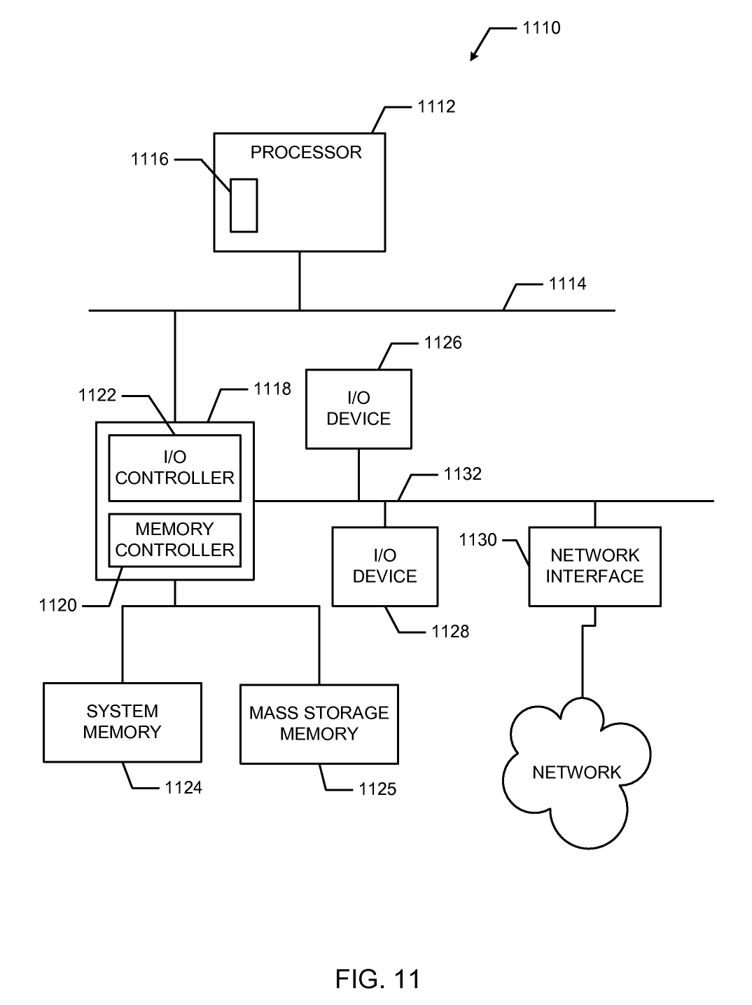

Flowcharts representative of example machine readable instructions for implementing the system 200 of FIG. 2 is shown in FIGS. 3-5, FIGS. 7A and 7B, and FIG. 9. In this example, the machine readable instructions comprise a program for execution by one or more processors such as the processor 1112 shown in the example processor system 1110 discussed below in connection with FIG. 11, a controller, and/or any other suitable processing device. The program(s) may be embodied in software stored on a tangible medium such as, for example, a flash memory, a CD-ROM, a floppy disk, a hard drive, a digital versatile disk (DVD), or a memory associated with the processor 1112, but the entire program and/or parts thereof could alternatively be executed by a device other than the processor 1112 and/or embodied in firmware or dedicated hardware (e.g., it may be implemented by an application specific integrated circuit (ASIC), a programmable logic device (PLD), a field programmable logic device (FPLD), discrete logic, etc.). For example, any or all of the data assembly engine 202, the seasonal index adjustor 210, the channel activity estimator 212, the synthetic time generator 214, and/or the projection engine 216 could be implemented (in whole or in part) by software, hardware, firmware and/or any combination of software, hardware and/or firmware. Thus, for example, any of the example data assembly engine 202, the example seasonal index adjustor 210, the example channel activity estimator 212, the example synthetic time generator 214, and/or the example projection engine 216 could be implemented by one or more circuit(s), programmable processor(s), ASIC(s), PLD(s) and/or FPLD(s), etc. When any of the appended claims are read to cover a purely software implementation, at least one of the example data assembly engine 202, the example seasonal index adjustor 210, the example channel activity estimator 212, the example synthetic time generator 214, and/or the example projection engine 216 are hereby expressly defined to include a tangible medium such as a memory, a DVD, a CD, etc.

Also, some or all of the machine readable instructions represented by the flowcharts of FIGS. 3-5, 7A, 7B, and 9 may be implemented manually. Further, although the example program is described with reference to the flowcharts illustrated in FIGS. 3-5, 7A, 7B, and 9, many other methods of implementing the example machine readable instructions may alternatively be used. For example, the order of execution of the blocks may be changed, and/or some of the blocks described may be changed, substituted, eliminated, or combined.

The program of FIG. 3 begins at block 302 where information from the databases of interest is assembled. As discussed above, the example system to weight incomplete respondent data shown in FIG. 2 employs an example incomplete database 204, a complete database 206, and a geodemographic database 208. The data from the databases may include information relevant to a number of channels (e.g., retailers of a particular type). Channels may include, but are not limited to, grocery supermarkets, pharmacies, mass-merchandisers, club stores, and/or convenience stores. In the illustrated example of FIG. 3, a channel of interest is selected (block 304) and seasonal correction factors are determined (block 306) before an estimate of spending within that channel is made (block 308). Estimations of spending within any particular channel, as described above, may include direct estimations (e.g., surveys) and/or statistical estimations.

Products and/or services within any selected channel may experience seasonal fluctuations, such as fluctuations in volume sales based on holidays (e.g., Christmas, Valentines Day, Easter, etc.). Complete and/or incomplete data acquired within a particularly high representative period or a particularly low representative period may skew projections if such seasonal demand factors are not considered. Accordingly, the example seasonal index adjustor 210 of FIG. 2 calculates adjustment indicies to reduce skewing errors (block 306). Synthetic times for respondents of the incomplete data are calculated (block 310) to facilitate projections (block 312). If data related to additional channels are available (block 314), control returns to block 304 to select an alternate channel and calculate synthetic time for the respondents.

### Data Assembly

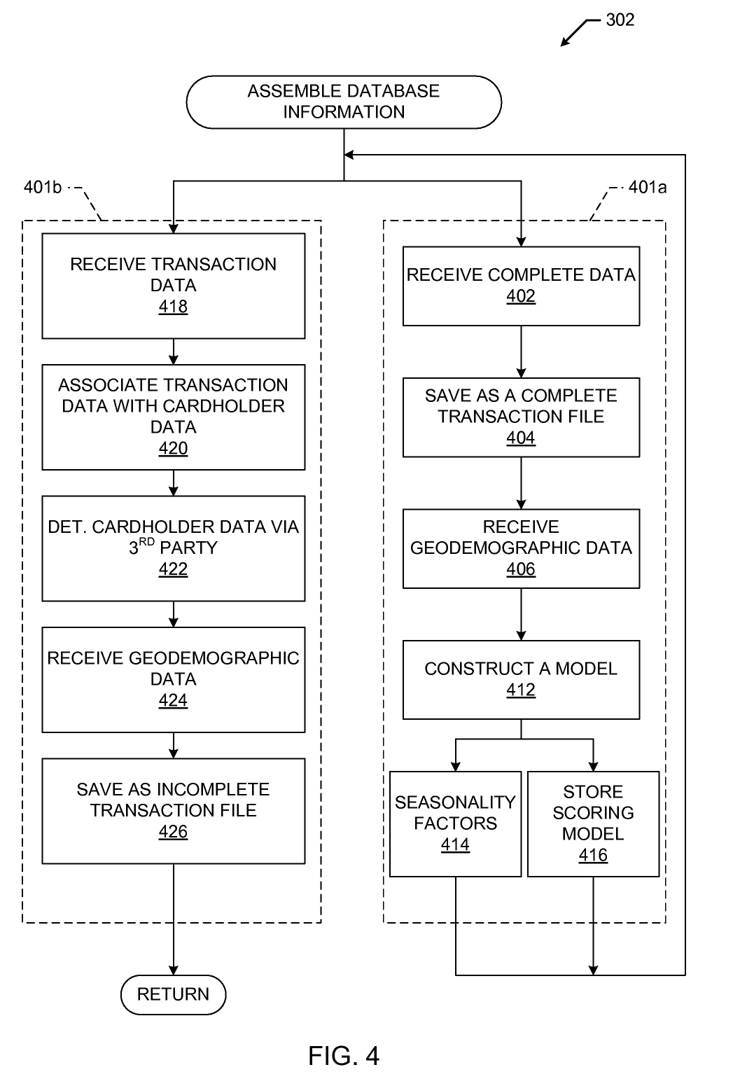

FIG. 4 illustrates an example manner of assembling database information (block 302) in detail. The example data assembly engine 202 of FIG. 2 facilitates data assembly for both complete data 401a and incomplete data 401b sources. In the illustrated example of FIG. 4, assembly of complete data 401a begins with the data assembly engine 202 receiving complete data for a specified time span (block 402) and saving such data in a complete data transaction file (block 404). The transaction file may be stored in the example data analysis database 218 of FIG. 2 and accessed at a later time by the projection engine 216 to generate projections to a larger population (e.g., a larger universe). The example data assembly engine 202 of FIG. 2 also receives geodemographic information (block 406) from the example geodemographic database 208 before constructing a model of relationships, as described in further detail below.

The example data assembly engine 202 constructs and/or employs a model of relationships between incomplete data and complete data (block 412). Models created by the data assembly engine 202 may include one or more degrees of complexity, such as a relatively simple model based on a survey using complete data and a survey using the incomplete data. One or more models may be used to verify how much to increase and/or decrease projection estimates based on comparisons between complete and incomplete survey results. Additionally or alternatively, one or more models may be based on respondent classification(s). For example, data related to grocery purchasing may be analyzed to determine whether the respondent(s) purchased baby food, diapers, and/or formula. Based on one or more particular purchases of this type, the respondent(s) may be classified as “persons/people with children.” Such classifications may be made in view of complete and incomplete data. For a respondent that has been classified as, for example, “a person with children,” the model created by the example data assembly engine 202 (block 412) may associate the purchases with voluntarily provided phone and/or address information collected when the panelist(s) were selected and/or when the respondent(s) applied for loyalty shopping card(s), thereby facilitating a better demographic understanding of the respondent(s). Equation 6 illustrates an example scoring model to generate relationships between incomplete data and complete data (block 416).

ChanEstimate=(ID)+a+b(CD)(DemographicAdjuster) Equation 6.

In the illustrated example Equation 6, ID reflects behavior data (e.g., spending data) from one or more incomplete data sets, CD reflects behavior data (e.g., spending data) from one or more complete data sets, and variables a and b reflect example regression analysis factors. For example, a regression analysis factor may include an assumption that everyone spends $50 for a particular channel during each visit.

In the illustrated example of FIG. 4, the model generated by the example data assembly engine 202 (block 412) is adjusted for seasonality factors (block 414) and/or the scoring model is saved to the example analysis database 218 of FIG. 2 as a channel statistics file (block 416). Without limitation, adjustments based on seasonality factors may be determined and/or applied to the complete and/or incomplete data (block 306) after selecting a channel of interest (block 304). The channel statistics file saved in the database 218 (block 416) may include one or more equations, examples of which are described in further detail below, and used for later calculations, projections, and/or estimations.

In addition to assembling complete data (blocks 402 through 416), the example data assembly engine 202 of FIG. 2 also assembles incomplete data 401b. In the illustrated example of FIG. 4, the data assembly engine 202 receives incomplete transaction data (block 418). The incomplete transaction data received (block 418) may indicate how much money was spent by one or more respondents. Additionally, the incomplete transaction data is associated with cardholder data (block 420), which may include data (e.g., home telephone number, home address, number of household members, age, sex, etc.) voluntarily provided by the respondent(s) when requesting and/or registering for a loyalty shopping card. As described above, while examples described herein are specific to shopping and/or loyalty cards, incomplete data may, without limitation, be associated with other types of respondent behaviors. For instance, respondent behaviors represented by incomplete data may include, but are not limited to, on-line (e.g., Internet) activity or media consumption and/or exposure (e.g., broadcast television, cable television, satellite television, etc.).

In the illustrated example of FIGS. 2 and 4, additional respondent information is derived by the example data assembly engine 202 if voluntarily provided respondent data is limited (block 422). For example, if a respondent only provided a telephone number when applying for a loyalty card, the data assembly engine 202 may access third party data sources to augment the respondent data associated with the loyalty card (block 422). The third party data sources may include, but are not limited to, telephone records, department of motor vehicle (DMV) records, government census data/databases, etc. To that end, the example data assembly engine 202 may utilize a provided telephone number to derive a more precise geographic location of the respondent. Additionally or alternatively, if the respondent provided information related to a drivers license number and/or a license plate number, the example data assembly engine 202 may reference the DMV to determine the type of car driven by the respondent. Such additional information may allow additional and/or alternative conclusions to be made with respect to the observed respondent behavior(s). The example data assembly engine 202 of FIG. 2 also receives geodemographic information (block 424) from the example geodemographic database 208 and saves it as an incomplete transaction file (block 426) in the analysis database 218 for later calculations, projections, and/or estimations, such as model construction as described in view of block 412.

### Channel Activity Estimation

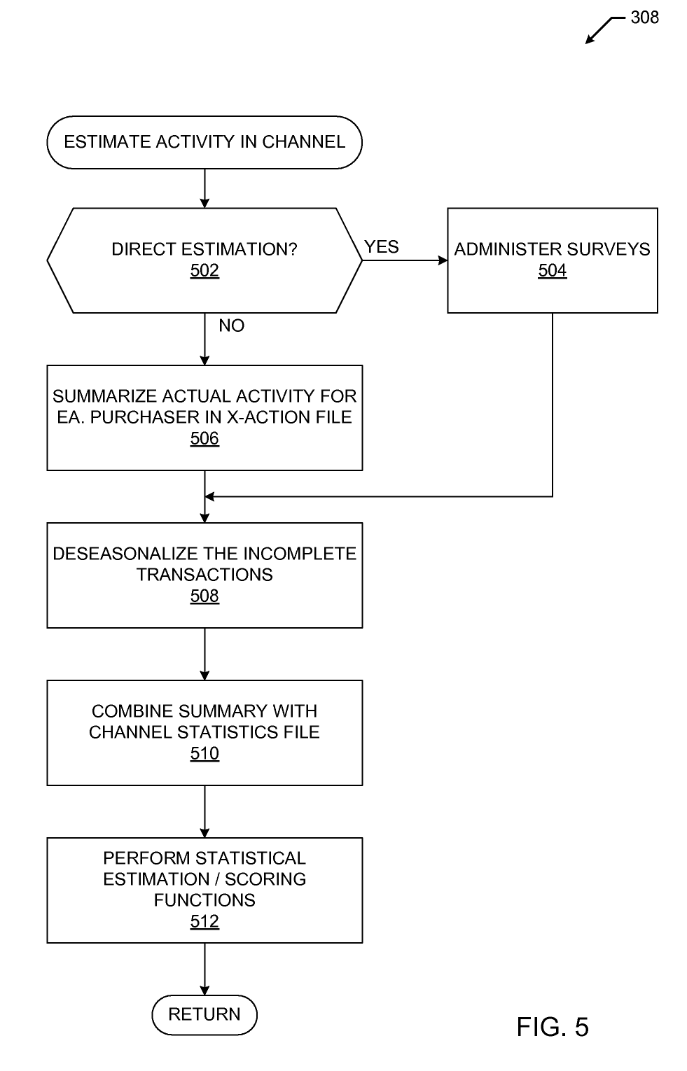

An example manner by which the example channel activity estimator 212 of FIG. 2 estimates activity/behavior in the selected channel (block 308) is shown in FIG. 5. As described above, the channel activity estimator 212 facilitates either direct estimations or statistical estimations. If an estimation is based on a direct approach (block 502), such as, for example, surveys, then the channel activity estimator 212 receives data indicative of channel activity (e.g., spending) via the administered surveys (block 504). On the other hand, if an estimation is based on statistical methods (block 502), then the channel activity estimator 212 summarizes actual activity for each respondent (e.g., purchaser) in the transaction file (block 506). The incomplete transactions are deseasonalized (block 508), the summary information is combined with the channel statistics file (block 510), and a statistical estimation is performed (block 512) (e.g., the estimation of excess life), as described above. Generally speaking, scoring functions, such as those stored in association with the scoring model (block 416) are applied (block 512).

Estimations of channel activity (block 512) (e.g., spending) may be performed via any statistical methodology, including, but not limited to, assuming that the class of purchasers annual spending in a channel may be described by a triangle distribution. The triangle distribution is employed as an initial approximation for data having an unknown distribution. Values for the distribution lie between real numbers A and C, in which the probability density has a maximum of B somewhere between A and C. Example Equations 7 and 8 illustrate density functions f(x).

$$\begin{matrix}f ( x ) = \frac{2 ( x - A )}{( B - A ) ( C - A )} if A \leq x \leq B . & Equation 7 \\ f ( x ) = \frac{2 ( C - x )}{( C - B ) ( C - A )} if B \leq x \leq C . & Equation 8\end{matrix}$$

Application of statistical definitions results in a cumulative distribution function F(z), which is the probability that a random observation from this distribution is less than or equal to z, as shown in example Equation 9.

$$F ( z ) = {\int }_{A}^{Z} f ( x ) d x . \qquad Equation 9$$

Accordingly, an expected value (e.g., mean) E(x) of the distribution is shown by example Equations 10 and 11.

$$\begin{matrix}E ( x ) = {\int }_{A}^{C} x * f ( x ) d x . & Equation 10 \\ E ( x ) = \frac{A + B + C}{3} . & Equation 11\end{matrix}$$

If a particular respondent (e.g., purchaser) has a total behavior (e.g., spending) of Z, then the calculation for expected value of annual channel behavior X may be performed. In particular, a density function for estimating the value V (which is the random variable describing X when it is at least as big as Z), is shown by example Equation 12.

$$g ( v ) = \frac{f ( x )}{1 - F ( Z )} if Z \leq x \leq C , otherwise 0. \qquad Equation 12$$

Example Equation 12 facilitates calculation of expected value E(X|Z) (which is the expected value of X given that X is greater than Z), as shown in Equation 13.

$$E ( X \vert Z ) = {\int }_{Z}^{C} v * g ( v ) d v . \qquad Equation 13$$

Example Equation 12 may be simplified, as shown by example Equations 14 and 15.

$$\begin{matrix}E ( X \vert Z ) = \frac{E ( X ) - F ( Z ) * \frac{( A + 2 * Z )}{3}}{1 - F ( Z )} if A \leq Z \leq B . & Equation 14 \\ E ( X \vert Z ) = \frac{2 * Z + C}{3} if B \leq Z \leq C . & Equation 15\end{matrix}$$

To account for extremely high or extremely low values of Z, example Equations 16 and 17 may be applied.

E(X|Z)=E(X) if Z<A Equation 16.

E(X|Z)=Z if Z>C Equation 17.

As described above, equations 14 through 17 are stored in the database 218 (block 416) and used for later calculations, projections, and/or estimations.

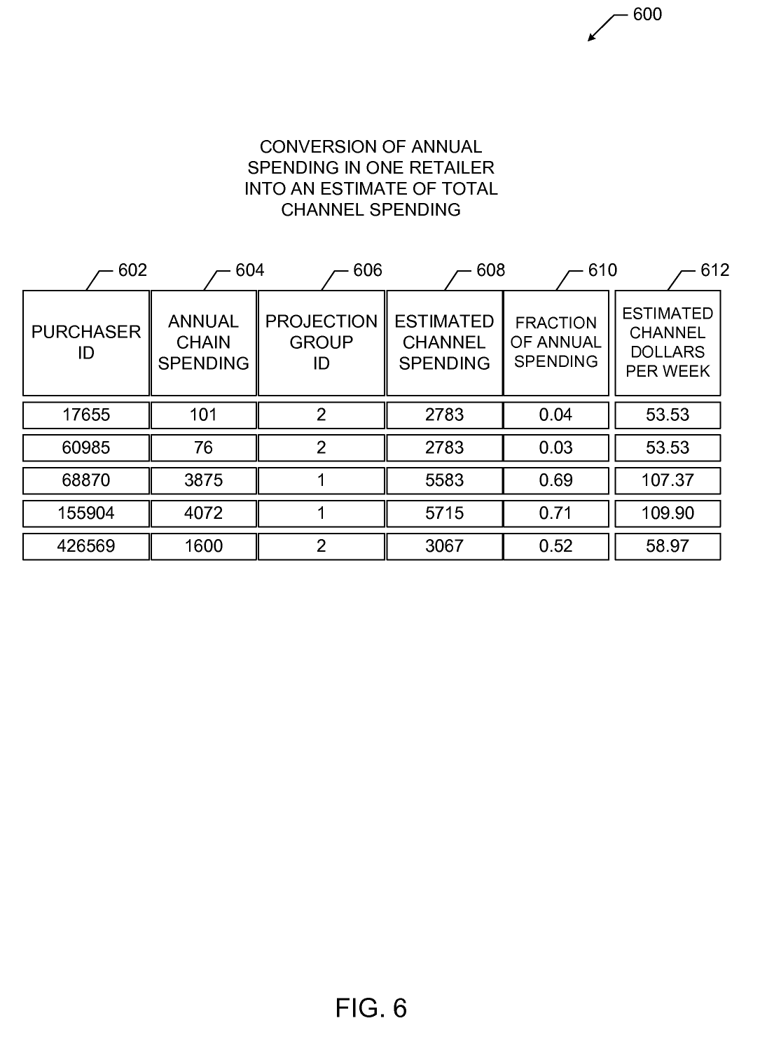

In the illustrated table 600 of FIG. 6, the selected statistical estimation methodology converts observed annual behavior within a specific retailer to an estimate of behavior for the selected channel. The example table 600 is shown in FIG. 6 that illustrates data for five (5) purchasers where the annual spending of each purchaser is known. As discussed above, examples related to spending and/or retail behavior are shown for exemplary purposes and the subject matter described herein is not limited thereto. The example table 600 illustrates activity in which spending occurs at a retailer. The example table 600 includes a column for purchaser identifiers 602, annual chain-spending 604, a projection group identifier 606, an estimated channel spending 608, a fraction of annual spending 610, and an estimated channel dollars per period 612 (e.g., per week, day, month, hour, etc.). For example, projection group 1 (purchasers with children) includes a distribution in which A=$1300, B=$1900, and C=$9000. Application of example Equation 11 yields a mean distribution of E(X)=$4066.67. Additionally, projection group 2 (purchasers without children) includes a distribution in which A=$900, B=$1450, and C=$6000. Application of example Equation 11 yields a mean distribution of E(X)=$2783.33.

As shown in the example table 600 of FIG. 6, purchaser “17655” is in group 2 and has an annual spending in the retail chain of $101. However, because this value is less than the lower limit A of $900 for group 2, the expected channel spending for this purchaser is set equal to the expected value for the group, which is $2783.33. Dividing the annual spending in the retail chain (i.e., $101) by the expected value for group 2 yields an estimated 4%, as shown in the fraction of annual spending column 610. Additionally, dividing the expected value for the group by 52 weeks yields an average spending of $53.53 per week for the corresponding purchaser.

The example seasonal index adjustor 210 of FIG. 2 considers market factors that may result in particularly high and/or low periods of activity, depending on seasonal factors. For example, barbeque sauce products may exhibit a relatively significant increase in sales volume during the mid summer months as compared to colder winter months, and/or chocolate products may exhibit a relatively significant increase in sales volume during Christmas and/or Valentines Day holiday periods. Data collected from purchasers, whether complete data or incomplete data, is not inherently adjusted to accommodate for periods of relatively high and/or low activity. Thus, reliance upon such un-adjusted data-points throughout the year may induce skewing effects on projections that use such data.

### Seasonal Adjustment

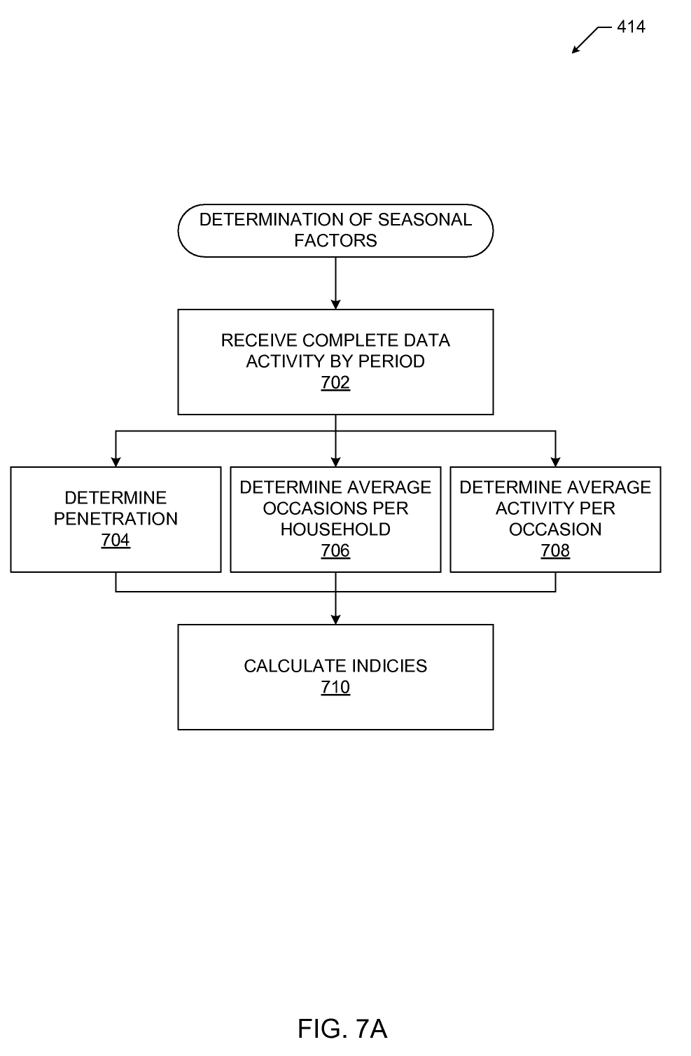

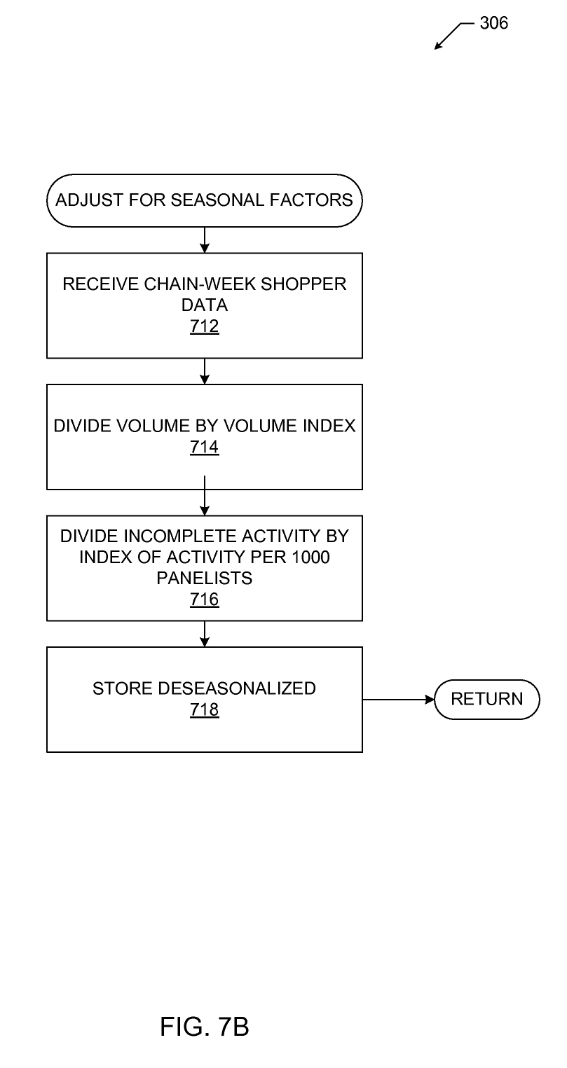

FIG. 7A illustrates an example program to determine seasonal factors, such as the seasonality factors discussed in view of FIG. 3 (block 306) and/or FIG. 4 (block 414). In particular, the example seasonal index adjustor 210 receives complete data activity (e.g., behavior(s) such as shopping) by period (e.g., day, month, week, etc.) (block 702). The example seasonal index adjustor 210 may calculate penetration (block 704), average occasions per respondent and/or household (block 706), and average activity per occasion (block 708) in any order without dependency therebetween. Calculation of penetration (block 704) may include a percentage of panel members with observed activity by period within a selected demographic group, for example. Similarly, calculation of the average occasions per respondent (e.g., buyer) (block 706) may include such occasions per buying household by period (e.g., hours, days, weeks, months, etc.) in view of one or more selected demographic groups. A standard sales per capita calculation includes the product of penetration, occasions per buyer, and volume per occasion, each of which are used to calculate one or more indicies (block 710).

FIG. 7B illustrates an example program to adjust for seasonal factors that is more specific to retail shopper activity. As described above, examples related to shopping/buying, channel spending, and/or retail activity are presented for illustrative purposes and are not intended to limit the subject matter described herein. In the illustrated example of FIG. 7B, the example seasonal index adjustor 210 receives chain-week shopper spending data (block 712) from the example analysis database 218. Chain-week (or any other sample period) shopper data represents a count of the number of purchasers that had one or more shopping occasions in the chain for an identified week (w). The activity, such as a volume, is divided by a volume index (block 714), and the incomplete activity is divided by an activity for an alternate volume (block 716). For example the incomplete activity is divided by the index of activity per 1000 panelists, and the deseasonalized information is stored for later use (block 718).

Additionally or alternatively, the example seasonal index adjustor 210 may calculate a volume for a given number of shoppers in a chain, and calculate the expected number of total equivalent households in the pool of households from which shoppers are drawn. In particular, the seasonal index adjustor 210 may include a summary of channel activity for all panelists, and a count of the number of panelists engaging in the activity. For retail purchasing, this would take the form of total dollar volume and number of shoppers. Using the complete data, a volume per shopper number and a penetration fraction would be calculated for each week (w), as shown by example Equations 18 and 19, respectively.

$$\begin{matrix}VolPerXShopper = \frac{X * Volume ( w )}{NumOfShoppers ( w )} . & Equation 18 \\ Penetration ( w ) = \frac{NumOfShoppers ( w )}{TotalNumOfPanelists} . & Equation 19\end{matrix}$$

Additionally, the example seasonal index adjustor 210 of FIG. 2 may also calculate the volume per panelist (also referred to as volume per capita) for quality control purposes. The volume per panelist is equal to the volume per shopper multiplied by the fraction of panel shopping, and is calculated as shown in example Equation 20.

$$VolPerXCapita = \frac{X * Volume ( w )}{TotalNumOfPanelists} . \qquad Equation 20$$

From the derived values of Equations 18 and 19, the example seasonal index adjustor 210 calculates indicies appropriate for projections and/or estimates. In particular, the seasonal index adjustor 210 may calculate a volume per shopper index, and a volume per capita index, as shown by example Equations 21 and 22, respectively.

$$\begin{matrix}VolPerShopperIndex ( w ) = \frac{\begin{matrix}100 * \\ VolPerXShopper ( w )\end{matrix}}{avg ( VolPerXShoppers )} . & Equation 21 \\ VolPerCapitaIndex ( w ) = \frac{\begin{matrix}100 * \\ VolPerXPanelists ( w )\end{matrix}}{avg ( VolPerXPanelists )} . & Equation 22\end{matrix}$$

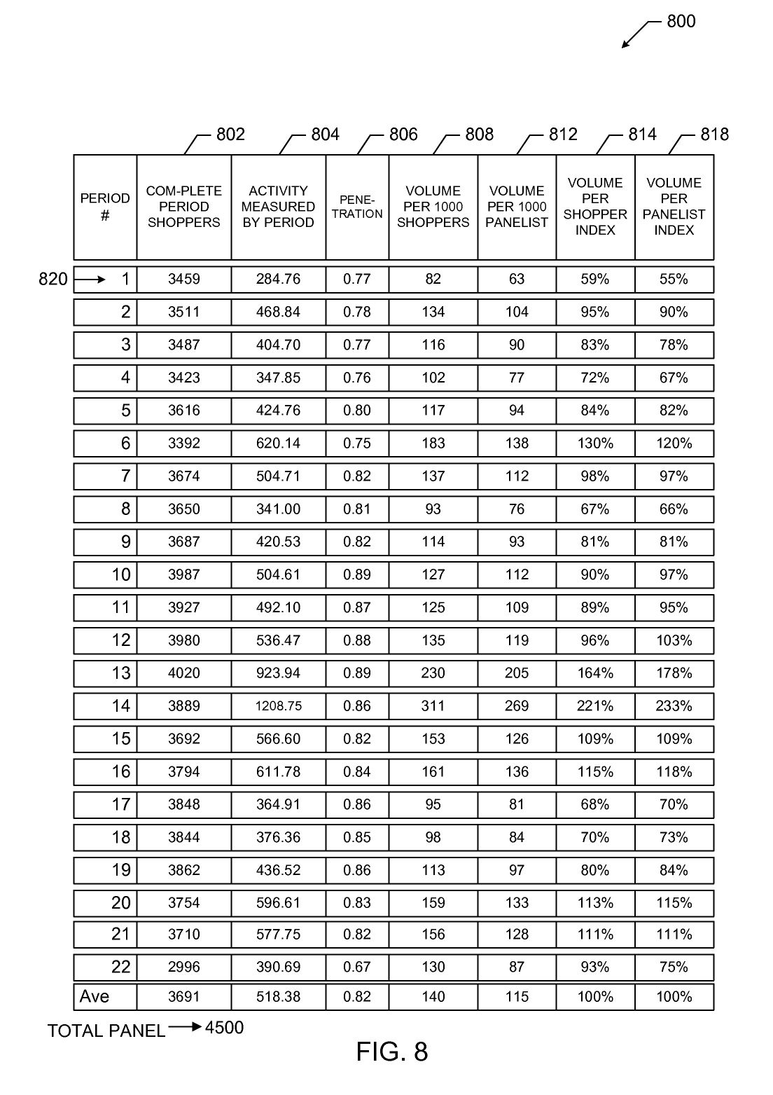

To illustrate the retail shopping example further, FIG. 8 includes an example table 800 for shopping behavior during a span of twenty-two (22) weeks for a panel of 4500. The example table 800 of FIG. 8 includes a corresponding column for data received from the example analysis database 218, and columns of data corresponding to values calculated from example Equations 18-22. In particular, the example table 800 of FIG. 8 includes a complete-period shoppers column 802 (e.g., such as a week or any other period), an activity measurement by period column 804 (e.g., dollar spending), and the total size of the complete panel, all of which represent data received from the example analysis database 218. Additionally, the example table 800 of FIG. 8 includes a penetration fraction column 806, and a volume per X shoppers column 808. As shown in example row 1 (820), the calculated value for the transaction fraction (volume 806) was obtained in view of example Equation 19 to yield a value of 82.

The example table 800 also includes a volume per 1000 panelists column 812, a volume per shopper index column 814, and volume per panelist volume index column 818. Values for each of columns 812 through 818 may be derived via example Equations 20 through 22.

### Synthetic Time Generation

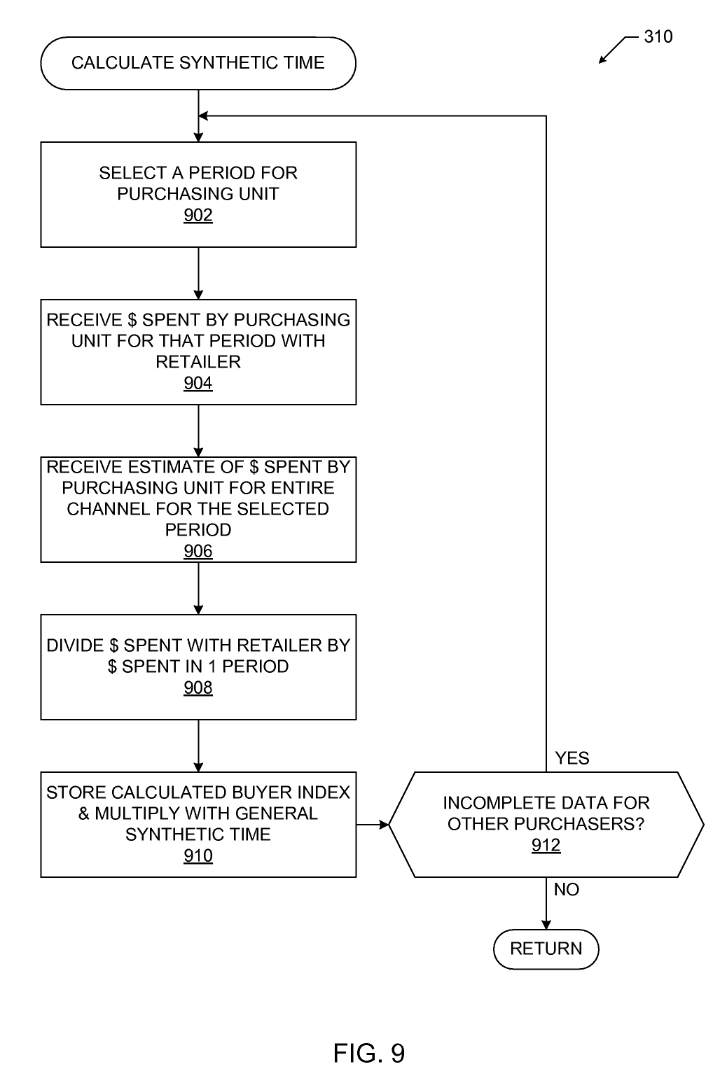

An example manner by which the synthetic time generator 214 calculates synthetic time indices (FIG. 3, block 310), is shown in FIG. 9. The synthetic time generator 214 selects a particular period (e.g., week) for a particular purchaser (sometimes referred to as a purchasing unit) (block 902), and receives the corresponding amount of money spent by that purchaser with the retailer (block 904). As described above, the data corresponding to the period, purchaser, and corresponding amount of money spent by the purchaser was saved in the example analysis database 218 while assembling the database information (block 302). The synthetic time generator 214 receives the estimate of money spent by the purchaser for the entire channel for the selected period (block 906), which was previously calculated by the example channel activity estimator 212. In particular, for the example purchaser “17655” in FIG. 6, the estimated channel dollars spent per week was $53.53. As such, dividing the money spent during a subject event by dollars spent in one period of interest (block 908) (e.g., a week, a month, etc.) yields a general synthetic time index of 0.029. However, to compensate for seasonal variations, the example synthetic time generator 214 stores the calculated buyer index (see week 2 from example table 800 of FIG. 8) and multiplies it with the general synthetic time to calculate the synthetic time for that product (block 910).

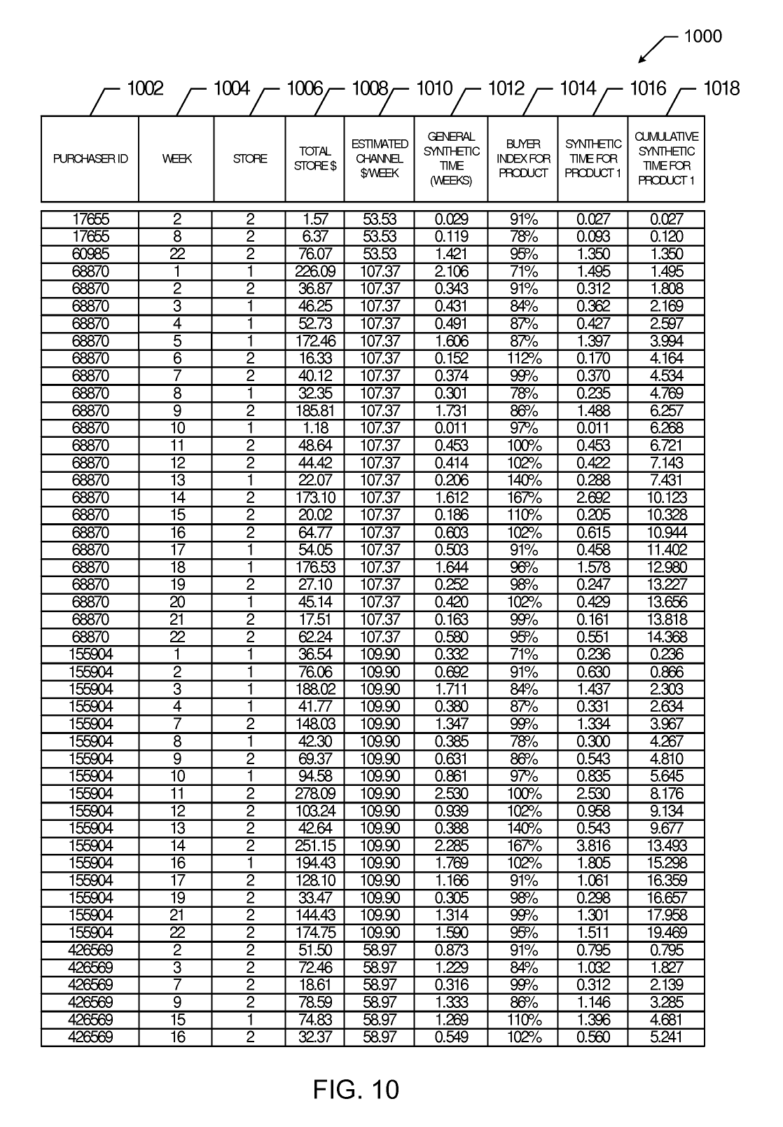

FIG. 10 illustrates an example table 1000 that tabulates (calculates) synthetic time indicies for each shopping occasion. The example table 1000 of FIG. 10 includes a column for one or more purchasers 1002, a corresponding week column 1004 in which data was obtained, and a store identifier column 1006. Additionally, the example table 1000 illustrates a column representing total store dollars spent 1008 in each shopping occasion, an estimated channel dollars spent per week 1010 (which is obtained from the example table 600 of FIG. 6), and a corresponding column representing a calculated general synthetic time 1012. The example table 1000 also illustrates an example buyer index for a particular purchased product 1014 (which is obtained from the example table 800 of FIG. 8), a column for synthetic time indicies 1016 that are calculated in view of seasonal variations, and a column representing cumulative synthetic time for that product 1018. Returning to FIG. 9, if there is additional incomplete data for other purchasers (block 912), then control returns to block 902. Calculations within columns 914, 916, and 918 would be repeated for each particular product, and iterative loops of the example program shown in FIG. 9 facilitate tabulation of the example table 1000 of FIG. 10.

Returning to FIG. 3, the example projection engine 216 of FIG. 2 may employ any number of statistical projection techniques using the calculated indicies of the example table 1000 of FIG. 10 (block 312). Projections calculated by the example projection engine 216 include, but are not limited to, market share, brand penetration, and volume per purchaser. If additional channels are available to be analyzed (block 314), then control returns to block 304 to select an alternate channel and calculate synthetic time for the purchasers of that selected channel.

FIG. 11 is a block diagram of an example processor system 1110 that may be used to execute the example machine readable instructions of FIGS. 3-5, 7A, 7B, and/or 9 to implement the example systems, apparatus, and/or methods described herein. As shown in FIG. 11, the processor system 1110 includes a processor 1112 that is coupled to an interconnection bus 1114. The processor 1112 includes a register set or register space 1116, which is depicted in FIG. 11 as being entirely on-chip, but which could alternatively be located entirely or partially off-chip and directly coupled to the processor 1112 via dedicated electrical connections and/or via the interconnection bus 1114. The processor 1112 may be any suitable processor, processing unit or microprocessor. Although not shown in FIG. 11, the system 1110 may be a multi-processor system and, thus, may include one or more additional processors that are identical or similar to the processor 1112 and that are communicatively coupled to the interconnection bus 1114.

The processor 1112 of FIG. 11 is coupled to a chipset 1118, which includes a memory controller 1120 and an input/output (I/O) controller 1122. A chipset typically provides I/O and memory management functions as well as a plurality of general purpose and/or special purpose registers, timers, etc. that are accessible or used by one or more processors coupled to the chipset 1118. The memory controller 1120 performs functions that enable the processor 1112 (or processors if there are multiple processors) to access a system memory 1124 and a mass storage memory 1125.

The system memory 1124 may include any desired type of volatile and/or non-volatile memory such as, for example, static random access memory (SRAM), dynamic random access memory (DRAM), flash memory, read-only memory (ROM), etc. The mass storage memory 1125 may include any desired type of mass storage device including hard disk drives, optical drives, tape storage devices, etc.

The I/O controller 1122 performs functions that enable the processor 1112 to communicate with peripheral input/output (I/O) devices 1126 and 1128 and a network interface 1130 via an I/O bus 1132. The I/O devices 1126 and 1128 may be any desired type of I/O device such as, for example, a keyboard, a video display or monitor, a mouse, etc. The network interface 1130 may be, for example, an Ethernet device, an asynchronous transfer mode (ATM) device, an 802.11 device, a digital subscriber line (DSL) modem, a cable modem, a cellular modem, etc. that enables the processor system 1110 to communicate with another processor system.

While the memory controller 1120 and the I/O controller 1122 are depicted as separate functional blocks within the chipset 1118 in FIG. 11, the functions performed by these blocks may be integrated within a single semiconductor circuit or may be implemented using two or more separate integrated circuits.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. A method to weight incomplete respondent data comprising:
assembling a set of complete data;
assembling a set of incomplete data;
selecting a channel of interest;
estimating activity within the selected channel; and
calculating synthetic time indicies for the set of incomplete data.

2. A method as defined in claim 1, wherein assembling the set of complete data further comprises receiving complete data for a specified time span.

3. A method as defined in claim 1, wherein assembling the set of complete data further comprises receiving geodemographic information.

4. (canceled)

5. (canceled)

6. A method as defined in claim 2, further comprising employing at least one model to generate a channel estimate based on behavior data and at least one regression analysis factor.

7. A method as defined in claim 6, wherein the behavior data comprises at least one of the set of complete data or the set of incomplete data.

8. A method as defined in claim 6, wherein the at least one regression analysis factor comprises a per-visit spending assumption.

9. A method as defined in claim 6, further comprising determining indicies based on seasonality factors.

10. A method as defined in claim 9, wherein determining indicies further comprises:
receiving a portion of the set of complete data by period; and
calculating at least one of penetration, average occasions per respondent, or average activity per occasion.

11. A method as defined in claim 1, wherein assembling the set of incomplete data further comprises receiving first cardholder transaction data.

12. A method as defined in claim 11, further comprising deriving second cardholder transaction data with at least one third party data source and the first cardholder transaction data.

13. (canceled)

14. A method as defined in claim 1, wherein estimating activity within the selected channel further comprises executing a triangle distribution estimation.

15. A method as defined in claim 1, wherein estimating activity within the selected channel further comprises converting retailer spending data into an estimate of total spending within the selected channel of interest.

16. A method as defined in claim 15, further comprising calculating at least one of a fraction of annual spending or channel dollars per period.

17. A method as defined in claim 1, wherein calculating synthetic time indicies further comprises:
selecting a period for a purchasing unit;
receiving a first value indicative of purchasing unit behavior with a retailer for the selected period;
receiving a second value based on the estimated activity within the selected channel; and
dividing the first value by the second value to generate a general synthetic time index.

18. A method as defined in claim 17, wherein the second value is based on money spent by the purchasing unit for the selected period.

19. A method as defined in claim 17, further comprising multiplying the general synthetic time index with a buyer index to calculate a seasonal synthetic time index.

20. An apparatus to weight incomplete data comprising:
a data assembly engine to assemble complete data and incomplete data;
a channel activity estimator to estimate respondent activity based on the assembled complete data and incomplete data; and
a synthetic time generator to calculate a respondent weight associated with the incomplete data.

21. An apparatus as defined in claim 20, further comprising a complete behavior database communicatively connected to the data assembly engine, the complete behavior database comprising panel data.

22. (canceled)

23. An apparatus as defined in claim 20, further comprising an incomplete behavior database communicatively connected to the data assembly engine.

24. (canceled)

25. (canceled)

26. An apparatus as defined in claim 20, further comprising a seasonal index adjustor to generate a seasonality index, the seasonality index indicative of an average annualized rate of activity.

27. An apparatus as defined in claim 20, further comprising a projection engine to calculate at least one of population measures, purchaser measures, market share, brand penetration, or volume per purchaser.

28. An article of manufacture storing machine accessible instructions that, when executed, cause a machine to:
assemble a set of complete data;
assemble a set of incomplete data;
select a channel of interest;
estimate activity within the selected channel; and
calculate synthetic time indicies for the set of incomplete data.

29. An article of manufacture as defined in claim 28, wherein the machine accessible instructions, when executed, cause the machine to receive complete data for a specified time span.

30. (canceled)

31. (canceled)

32. (canceled)

33. An article of manufacture as defined in claim 29, wherein the machine accessible instructions, when executed, cause the machine to employ at least one model to generate a channel estimate based on behavior data and at least one regression analysis factor.

34. An article of manufacture as defined in claim 33, wherein the machine accessible instructions, when executed, cause the machine to determine indicies based on seasonality factors.

35. An article of manufacture as defined in claim 34, wherein the machine accessible instructions, when executed, cause the machine to:
receive a portion of the set of complete data by period; and
calculate at least one of penetration, average occasions per respondent, or average activity per occasion.

36. (canceled)

37. (canceled)

38. (canceled)

39. An article of manufacture as defined in claim 28, wherein the machine accessible instructions, when executed, cause the machine to convert retailer spending data into an estimate of total spending within the selected channel of interest.

40. An article of manufacture as defined in claim 39, wherein the machine accessible instructions, when executed, cause the machine to calculate at least one of a fraction of annual spending or channel dollars per period.

41. An article of manufacture as defined in claim 28, wherein the machine accessible instructions, when executed, cause the machine to:
select a period for a purchasing unit;
receive a first value indicative of purchasing unit behavior with a retailer for the selected period;
receive a second value based on the estimated activity within the selected channel; and
divide the first value by the second value to generate a general synthetic time index.

42. An article of manufacture as defined in claim 41, wherein the machine accessible instructions, when executed, cause the machine to multiply the general synthetic time index with a buyer index to calculate a seasonal synthetic time index.
